(19) United States
(12) Patent Application Publication
(10) Pub. No.: US 2021/0164760 A1
(43) Pub. Date: Jun. 3, 2021

(54) INTEGRATED SHOOTING SIMULATION SYSTEM USING FISHEYE LENS CAMERA

(71) Applicant: Kook Jin LEE, Seoul (KR)

(72) Inventor: Kook Jin LEE, Seoul (KR)

(21) Appl. No.: 16/770,582

(22) PCT Filed: Nov. 26, 2018
(86) PCT No.: PCT/KR2018/014593

§ 371 Date: Jun. 5, 2020

(30) Foreign Application Priority Data
Dec. 7, 2017 (KR) 10-2017-0167736

(51) Int. Cl. F41G 3/26; A63F 13/837; G02B 13/06; H04N 5/225

(52) U.S. Cl. CPC F41G 3/2655; H04N 5/2257; G02B 13/06; A63F 13/837

(57) ABSTRACT

The present invention relates to an integrated shooting simulation system using a fisheye lens camera and, more particularly, to an integrated shooting simulation system using a fisheye lens camera, the system allowing shooting simulation system equipment to be formed in an integrated structure by using a fisheye lens camera so as to have free movable installation and be usable through simple installation and reinstallation without spatial constraints. The integrated shooting simulation system using a fisheye lens camera, according to the present invention, includes: a main body for implementing a shooting simulation by executing a shooting program; a display device for receiving images, which are related to the shooting simulation, from the main body, and displaying the same; a fisheye lens camera mounted at the display device and capturing a shooting image displayed on the display unit; and a simulation gun, wherein the main body and the display unit are integrally formed.

### TECHNICAL FIELD

The present invention relates to an integrated shooting simulation system using a fisheye lens camera, and more particularly, to an integrated shooting simulation system using a fisheye lens camera, in which the fisheye lens camera is used to integrally configure shooting simulation system devices, so that an installation space may be minimized, and reinstallation may be simplified.

### BACKGROUND ART

In general, as multimedia technologies and computer programming technologies develop, virtual experience devices which allow a user to have the same impression as in a real situation in a virtual space simulating the real situation and to experience situations that are difficult to be implemented in real situations are being developed.

For example, aircraft pilot training, indoor vehicle driving practice, or the like is performed in a virtual space simulated to be the same as a real situation.

In addition, such a scheme is applied in the field of sports/entertainment.

Application fields of a simulation technology have expanded because of advantages of the simulation technology such as training cost reduction and accident prevention effects. Recently, the simulation technology is also used in image shooting such as gun shooting training and shooting games.

Conventionally, screen shooting simulation technologies that allow soldiers, polices, and ordinary persons to experience realistic shooting with a simulation gun through a simulation in which an image on which a target is indicated is projected on a screen with a beam projector installed at a long distance, and the simulation gun is used to shoot an invisible laser at the target shown on the screen to hit the target have been disclosed.

As one example, Korean Unexamined Patent Publication No. 10-2016-0002258 (2016 Jan. 7) discloses a virtual shooting simulation apparatus capable of precisely controlling a simulation image correspondingly to a relation between a virtual figure on a screen and an aiming point position.

Korean Unexamined Patent Publication No. 10-2011-0001114 (2011 Jan. 6) discloses a method, a system, and a recording medium for a clay shooting simulation, in which software executed on a computer is used to process graphics using realistic actual background images in real time so as to allow a shooter performing shooting to aim and shoot a clay pigeon flying on a screen, the software controls hardware to interwork with the software so as to generate recoil of a gun during the shooting, and the screen displaying an aiming point of a laser inserted in a muzzle of the gun is captured and recognized to immediately determine whether a target is hit and inform a result thereof, so that the shooter may play a game by using a simulation gun that has an appearance of a real gun and a pigeon release scaffold for releasing the pigeon on the screen so as to practice the shooting while experiencing the shooting exactly the same as real shooting.

However, in the conventional shooting simulation system, there were many inconvenient problems that the distance and space of 3 M to 10 M or more are required to install devices such as a screen, a beam projector for projecting a target image onto the screen, and a camera for recognizing an impact point of an invisible laser shot from a simulation gun to the screen, a trajectory of a muzzle of the gun, and the target image to provide a recognition result to a control device, and the devices have to be individually reinstalled and set according to a location.

### DETAILED DESCRIPTION OF THE INVENTION

### Technical Problem

Therefore, in order to solve the above problems, an object of the present invention is to provide an integrated shooting simulation system using a fisheye lens camera, in which shooting simulation system devices are integrally configured, the fisheye lens camera is mounted to minimize an installation space, and mounting or installation may be facilitated.

### Technical Solution

In order to achieve the above object, according to the present invention, there is provided an integrated shooting simulation system using a fisheye lens camera, the integrated shooting simulation system including: a main body for implementing a shooting simulation by executing a shooting program; a display device for receiving an image, which is related to the shooting simulation, from the main body to display the received image; the fisheye lens camera mounted on the display device to capture a shooting image displayed on the display device; and a simulation gun, wherein the main body and the display device are integrally formed.

### Advantageous Effects of the Invention

According to the present invention, the integrated shooting simulation system using the fisheye lens camera has an integrated system structure, and the fisheye lens camera is mounted on the screen so that a separation distance between the camera and the screen is unnecessary, and thus the installation space can be minimized, free movement can be ensured, and reinstallation can be simplified.

### DESCRIPTION OF THE DRAWINGS

FIG. 1 is a view showing an overall configuration of an integrated shooting simulation system using a fisheye lens camera according to the present invention.

FIGS. 2a to 2c are views illustrating a mounting position of the fisheye lens camera of the system of FIG. 1.

FIG. 3 is a detailed view showing an internal configuration of a main body of the system of FIG. 1.

FIG. 4 is a flowchart for describing a shooting simulation method of the system of FIG. 1.

### BEST MODE

The best mode for implementing the present invention provides an integrated shooting simulation system using a fisheye lens camera, the integrated shooting simulation system including: a main body for implementing a shooting simulation by executing a shooting program; a display device for receiving an image, which is related to the shooting simulation, from the main body to display the received image; the fisheye lens camera mounted on the display device to capture a shooting image displayed on the display device; and a simulation gun, wherein the main body and the display device are integrally formed.

In a preferred embodiment, the fisheye lens camera may be mounted at one of an upper end, a lateral side, and a rear end of the display device.

In a preferred embodiment, the integrated shooting simulation system may further include a sensor for detecting a distance to a shooter.

In a preferred embodiment, the sensor may include an ultrasonic sensor, and may be mounted on the main body.

In a preferred embodiment, the main body may include: a control board for storing a shooting program, performing and managing the shooting simulation, and determining whether the distance to the shooter, which is detected by the sensor, is a valid shooting distance to generate an alarm when distance adjustment is required; a wired/wireless transceiver for receiving a trigger signal from the simulation gun, and transmitting a shooting result; a sound output device for outputting a sound generated when shooting the gun, and generating the alarm for adjusting a shooting position of the shooter; and a power supply device for supplying an operating power.

In a preferred embodiment, the control board may control the fisheye lens camera to capture an image screen of the display device and correct distortion of the captured image screen when the trigger signal is received, may detect an invisible laser signal, which is shot from the simulation gun, from the corrected image screen to calculate coordinates of the invisible laser signal, and may displays an impact point on the image screen of the display device corresponding to the calculated coordinates.

### MODE FOR INVENTION

Hereinafter, preferred embodiments of the present invention will be described in detail with reference to the accompanying drawings.

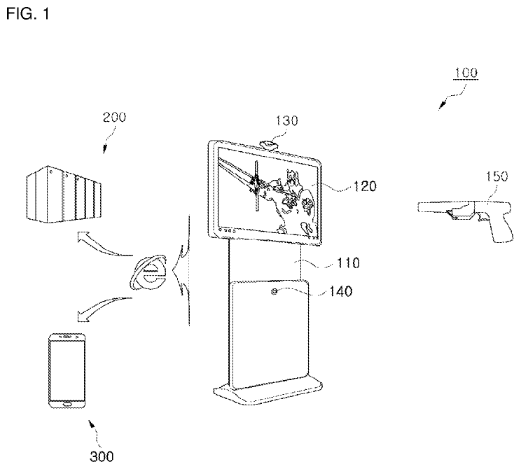

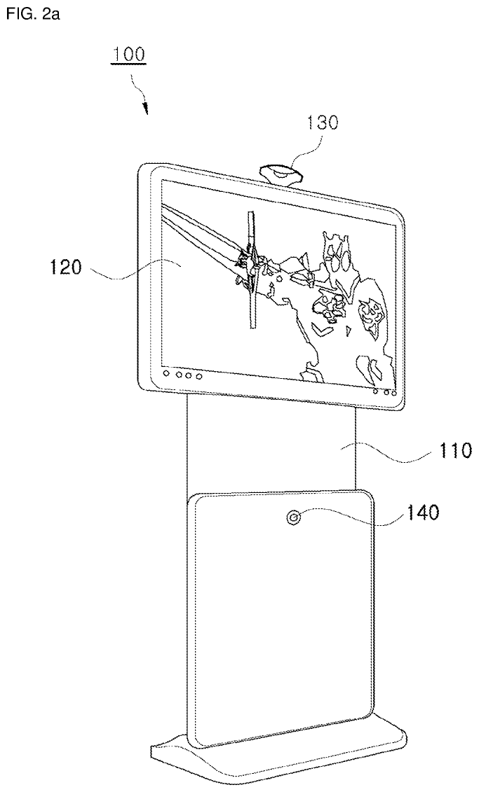

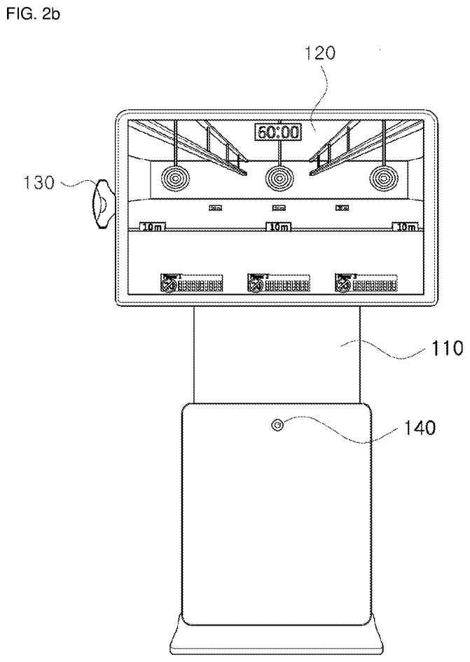

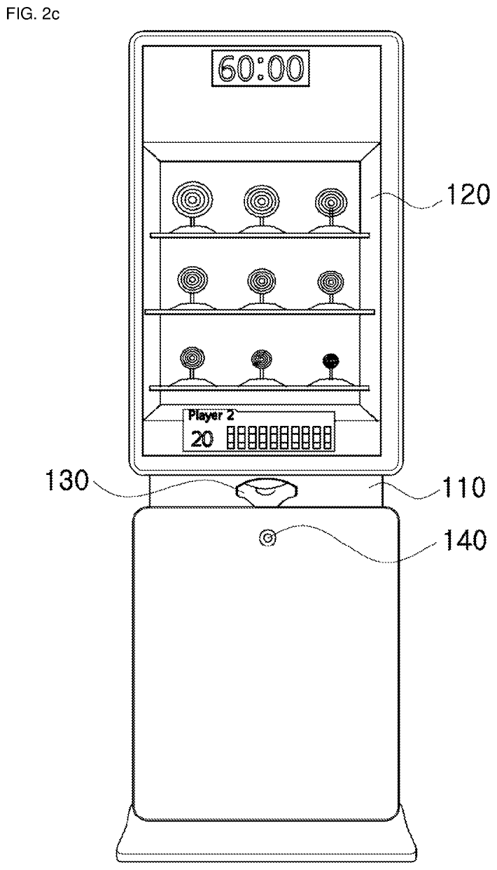

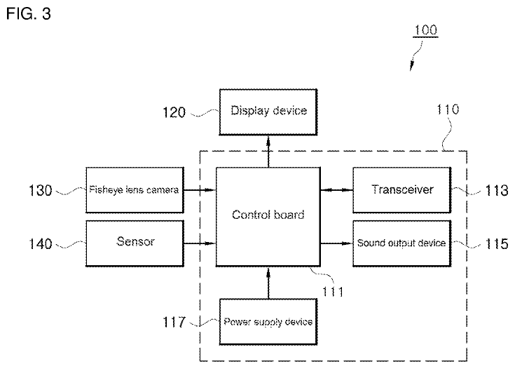

FIG. 1 is a view showing an overall configuration of an integrated shooting simulation system using a fisheye lens camera according to the present invention, FIGS. 2a to 2c are views illustrating a state in which the fisheye lens camera of the system of FIG. 1 is mounted, and FIG. 3 is a view showing an internal configuration of a main body of the system of FIG. 1.

As shown in the drawings, in a shooting simulation system 100 according to the present invention, a main body 110 for implementing a shooting simulation by executing a shooting program and a display device 120 for receiving an image, which is related to the shooting simulation, from the main body 110 to display the received image may be integrally configured.

A fisheye lens camera 130 for capturing an impact point of an invisible laser shot from a simulation gun 150 to the display device 120, a trajectory of a muzzle of the gun, and a target image may be mounted on the display device 120.

A fisheye lens refers to a super-wide-angle retrofocus lens with an angle of view exceeding 180°, in which, unlike general wide-angle lenses, an image is distorted when captured, that is, an image of a uniform brightness is formed on an entire screen with a barrel-shape curvature. Since the fisheye lens may capture an image in a wider angle than a general wide-angle lens, in the present invention using the fisheye lens camera 130, an image may be captured even without installing a camera to face a screen at a predetermined distance as in a conventional shooting simulation system using a general camera.

As shown in FIGS. 2a to 2c, the fisheye lens camera 130 may be mounted on various positions such as an upper end, a lateral side, or a lower end of the display device 120, but the positions are not limited thereto.

In the present embodiment, when the display device 120 has a horizontally-elongated structure as shown in FIGS. 2a and 2b, the fisheye lens camera 130 may be mounted on the upper end or the lateral side of the display device 120, and when the display device 120 has a vertically-elongated structure as shown in FIG. 2c, the fisheye lens camera 130 may be mounted on the lower end of the display device 120.

A sensor 140 for detecting a separation distance to a shooter may be mounted on the main body 110.

The sensor 140 may serve to monitor whether the shooter complies with a shooting reference distance.

In the present embodiment, an ultrasonic sensor may be used as the sensor 140.

In general, an ultrasonic sensor refers to a sensor for detecting a distance, a thickness, a movement, and the like by using characteristics of ultrasonic waves or by generating ultrasonic waves.

The simulation gun 150 may be provided to face the display device 120 at a position spaced apart from the display device 120 by a predetermined distance, may detect triggering of a trigger to output a trigger signal, and may generate and shoot the invisible laser toward a target displayed on the display device 120 when the trigger signal is output.

In this case, the simulation gun 150 may be connected to the main body 110 through wired or wireless communication.

As shown in FIG. 3, the main body 110 may include a control board 111, a transceiver 113, a sound output device 115, and a power supply device 117.

The control board 111 may store the shooting program, and may control each component to perform and manage the shooting simulation. The transceiver 113 may receive the trigger signal from the simulation gun 150 through the wired or wireless communication.

The sound output device 115 may process a sound, which is almost identical to an equipment sound effect generated during actual gun shooting, to output the processed sound to a speaker.

The power supply device 117 may supply a power required for an operation of each component.

Meanwhile, a management server 200 of FIG. 1 may be connected to each of the components of the shooting simulation system 100 through a network, in which shooting results of shooters may be registered in a database (DB) so as to be comprehensively managed.

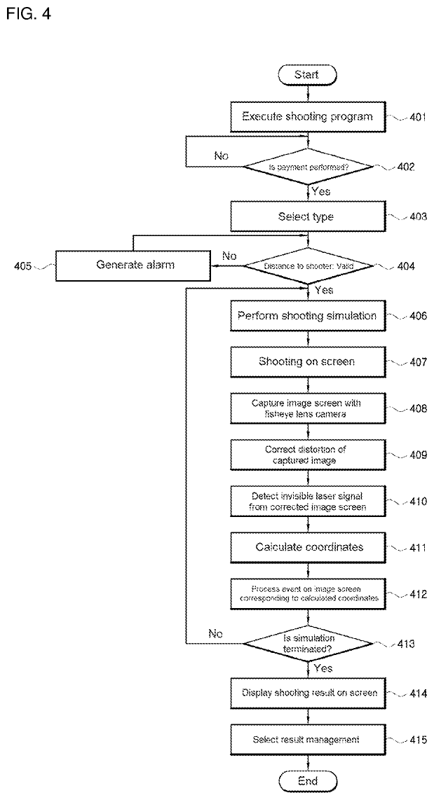

FIG. 4 is a flowchart for describing a shooting simulation method of the integrated shooting simulation system using the fisheye lens according to the present invention.

As shown in the drawing, when a shooting simulation program stored in the control board 111 of the main body 110 is executed, each hardware component constituting the system may be set, and a shooting program payment request screen may be displayed on the display device 120 (step 401).

The shooter may perform payment according to a shooting program payment request displayed on the display device 120. In this case, a payment scheme is not specifically limited.

The control board 111 of the main body 110 may confirm shooting program payment (step 402).

Next, the control board 111 may output a shooting program type selection screen to the display device 120, and may recognize a type selected by the shooter from the shooting program type selection screen (step 403).

As one example, there are various types of shooting programs including clay shooting for shooting a target flying at a high speed, shooting range for shooting targets that are vertically and horizontally arranged and stand up momentarily, and terror buster for annihilating terrorists armed with mortars and high-performance weapons in a virtual city for a predetermined period of time.

After the shooter selects the type of the shooting program, the shooter may stand in a shooting position with the simulation gun 150. At this time, the ultrasonic sensor 140 installed in the main body 110 may detect the distance to the shooter.

The control board 111 may determine whether the distance to the shooter, which is detected by the ultrasonic sensor 140, is a shooting distance valid for the selected type of the shooting program (step 404).

When the distance to the shooter is determined to be too short or too long, the control board 111 may generate an alarm through the sound output device 115 (step 405). The shooter may adjust the shooting position of the shooter as the alarm is generated.

When the distance to the shooter becomes valid, the control board 111 may perform a simulation of the selected type of the shooting program, and may display a target image suitable for the selected shooting program on the display device 120 (step 406).

The shooter may shoot the simulation gun 150 on a screen of the display device 120 (step 407). In this case, the shooter may aim a target displayed on the screen of the display device 120 with the simulation gun 150 and cause the triggering by pulling the trigger, and the triggering may cause the invisible laser to be shot toward the target on the screen of the display device 120.

The transceiver 113 of the main body 110 may receive the trigger signal of the simulation gun 150 and output the received trigger signal to the control board 111, and the control board 111 may control the fisheye lens camera 130 installed on the display device 120 to capture an image screen of the display device 120 when the trigger signal is input to the control board 111 (step 408).

The control board 111 may correct distortion of the captured image screen (step 409). Since the image screen captured by the fisheye lens camera 130 is distorted due to characteristics of the lens, the control board 111 may correct the image screen as if the image screen is taken with a general camera.

The control board 111 may detect an invisible laser signal from the corrected image screen (step 410), and may calculate coordinates of the detected laser signal (step 411).

Thereafter, the control board 111 may process an event to display an impact point on the image screen of the display device 120 corresponding to the calculated coordinates so that the shooter may determine whether the target is hit in real time (step 412).

The control board 111 may repeat the steps from step 406 until termination of the simulation of the selected type of shooting program is recognized (step 413).

When the selection program is terminated, the control board 111 may display a shooting result on the screen of the display device 120 (step 414). The shooting result may include a score according to accuracy of the laser hitting the target, a ranking of the shooter when there are multiple shooters, and the like.

The control board 111 may output a result management selection screen to the display device 120, and may recognize result management selected by the shooter from the result management selection screen (step 415).

When the shooter selects “register on the management server 200”, the control board 111 may communicate with the management server 200 to store the shooting result in the DB.

In addition, the control board 111 may receive the shooting result of the shooter registered in the DB of the management server 200.

The control board 111 may transmit the shooting result to a mobile phone 300 so that the shooter may receive the shooting result in the mobile phone 300 when the shooter selects “load to the mobile phone 300”. Meanwhile, the shooter may access the management server 300 through a login of the mobile phone 300 to load the shooting result stored in the management server 300 to the mobile phone 300 and observe the loaded shooting result at any time.

After the management of the shooting result, the control board 111 may terminate the program and proceed to a standby mode.

The shooting simulation system according to the present invention has an integrated structure, so that free movement can be ensured even if the shooting simulation system is reinstalled after changing an installation location, it is unnecessary to individually install system devices, and an occupied space can be reduced.

Although the integrated shooting simulation system using the fisheye lens camera according to one embodiment of the present invention has been described for illustrative purposes, the present invention is not limited to the above embodiments. It is understood that various changes and modifications can be made by a person having ordinary skill in the art to which the invention pertains without departing from the spirit and scope of the present invention as disclosed in the appended claims.

### INDUSTRIAL APPLICABILITY

As described above, the integrated shooting simulation system using the fisheye lens camera according to the present invention may be utilized in industries in the fields of military/police shooting training and leisure shooting sports.

1. An integrated shooting simulation system using a fisheye lens camera, the integrated shooting simulation system comprising:
a main body for implementing a shooting simulation by executing a shooting program; a display device for receiving an image, which is related to the shooting simulation, from the main body to display a received image;
the fisheye lens camera mounted on the display device to capture a shooting image displayed on the display device; and a simulation gun, wherein the main body and the display device are integrally formed.

2. The integrated shooting simulation system of claim 1, wherein the fisheye lens camera is mounted at one of an upper end, a lateral side, and a rear end of the display device.

3. The integrated shooting simulation system of claim 1, further comprising a sensor for detecting a distance to a shooter.

4. The integrated shooting simulation system of claim 3, wherein the sensor includes an ultrasonic sensor, and is mounted on the main body.

5. The integrated shooting simulation system of claim 3, wherein the main body includes:
a control board for storing a shooting program, performing and managing the shooting simulation, and determining whether the distance to the shooter, which is detected by the sensor, is a valid shooting distance to generate an alarm when distance adjustment is required; a wired/wireless transceiver for receiving a trigger signal from the simulation gun, and transmitting a shooting result; a sound output device for outputting a sound generated when shooting the gun, and generating the alarm for adjusting a shooting position of the shooter; and a power supply device for supplying an operating power.

6. The integrated shooting simulation system of claim 5, wherein the control board controls the fisheye lens camera to capture an image screen of the display device and correct distortion of an captured image screen when the trigger signal is received, detects an invisible laser signal, which is shot from the simulation gun, from a corrected image screen to calculate coordinates of the invisible laser signal, and displays an impact point on the image screen of the display device corresponding to a calculated coordinates.
